(19) United States
(12) Patent Application Publication
(10) Pub. No.: US 2003/0203680 A1
(43) Pub. Date: Oct. 30, 2003

(54) Electrical connector

(76) Inventors: Kamal S. Boutros, Richmond Hill (CA); Linlan Deng, Toronto (CA)

Correspondence Address: BLANK ROME LLP, 600 NEW HAMPSHIRE AVENUE, N.W., WASHINGTON, DC, 20037, US

(21) Appl. No.: 10/132,369

(22) Filed: Apr. 26, 2002

(51) Int. Cl. H01R 24/00

(52) U.S. Cl. 439/660

(57) ABSTRACT

The connector of the present invention includes a housing, an electrical contact insert and a wire holding block. The housing holds the insert and holding block in a first and second position. In the first position, the insert and holding block are positioned inside the housing, with the holding block being disengaged from the insert. An electrical cable with exposed wire leads is inserted into the holding block and the two are then pushed inward into the housing from the first position to the second position. In the second position, the wire leads of the electrical cable are engaged with rear metal contacts on the insert to electrically engage the cable with the connector.

### FIELD OF INVENTION

The present invention is directed towards a connector that is attached to an end of an electrical or data cable using a solderless process. In a preferred embodiment of the invention, the connector is a serial ATA cable receptacle that allows electronic equipment to quickly and easily “snap” onto other electronic components.

### BACKGROUND OF THE INVENTION

Electrical connectors are typically shipped to cable manufacturers in several pieces that must be assembled with an electrical cable before being sold. During the assembly process, the connector is secured to the electrical cable by soldering the cable's wire leads to metallic contacts inside the connector. The assembly and soldering process require additional tools and time, raising the manufacturing costs of the electrical cable and connector assembly.

### SUMMARY AND OBJECTS OF THE INVENTION

The serial ATA connector of the present invention includes a housing, an electrical contact insert and a wire holding block. The housing holds the insert and holding block in a first pre-assembly position for attaching an electrical cable, and a second locked position for securing the electrical cable to the connector. In the first position, the insert and holding block are positioned inside the housing, with the holding block being disengaged from the insert. An electrical cable with exposed wire leads is inserted into the holding block and the two are then pushed inward into the housing from the first position to the second position, where the wire leads of the electrical cable engage metal contacts of the insert.

The connector simplifies the manufacture and assembly of connectors with electrical cables, by shipping the connector to a cable manufacturer in the first position where it is joined with an electrical cable and manually moved to the second, assembled position. The connector is moved from its first position to its second position by simply pushing the components of the connector together.

Therefore, it is an object of the invention to provide a connector that comes pre-assembled so that it can be quickly and easily attached to an electrical cable.

It is a further object of the invention to provide a connector that can be manually assembled with an electrical cable.

It is still a further object of the invention to provide a connector that can be electrically connected to an electrical cable without having to solder the connector to the cable.

### BRIEF DESCRIPTION OF THE DRAWINGS

FIG. 1 shows an exploded perspective view of a first embodiment of a connector of the present invention and a cable attached thereto;

FIG. 2A shows a side view of the first embodiment of an electrical cable and insert;

FIG. 2B shows a perspective view of FIG. 2A with the addition of a wire holding block;

FIG. 2C shows a perspective view of FIG. 2B with the addition of a housing;

FIG. 2D shows a perspective view of FIG. 2C with the addition of an outer molding;

FIG. 3 shows a perspective view in cross-section of the first embodiment of the connector and electrical cable in a first position;

FIG. 4 shows a side cut-away view of the first embodiment of the connector and electrical cable in a second position;

FIG. 5 shows a front cut-away view along line 5-5 of FIG. 4;

FIG. 6 shows a perspective view of the first embodiment of the front portion of the holding block;

FIG. 7 shows an exploded view of a second embodiment of the connector of the present invention;

FIG. 8 shows a perspective view of the second embodiment of the holding block;

FIG. 9 shows a side view of the second embodiment of the connector in the second position; and

FIG. 10 shows a front view along line 10-10 of FIG. 9.

### DETAILED DESCRIPTION OF THE PREFERRED EMBODIMENT

Referring now to the several drawing figures in which identical elements are numbered identically throughout, a description of the preferred embodiment of the present invention will be provided.

FIG. 1 shows the various components of the connector 100 in an exploded view, specifically a housing 200, a contact insert 300 and a wire holding block 400. An electrical cable 500 is shown to help illustrate the features of the connector 100, but is not a part of the connector 100. FIGS. 2A-2D show the connector 100 and the cable 500, with the series of figures showing additional components of the connector 100 to help illustrate the relationship of the components. FIG. 2A shows the cable 500 attached to the insert 300. FIG. 2B shows the cable 500 and the insert 300 attached to the wire holding block 400. FIG. 2C shows the cable 500, the insert 300, and the wire holding block 400 inside the housing 200. FIG. 2D shows the cable 500, the insert 300, the wire holding block 400 and the housing 200 with an outer or over molding 600 placed over the housing 200 and cable 500.

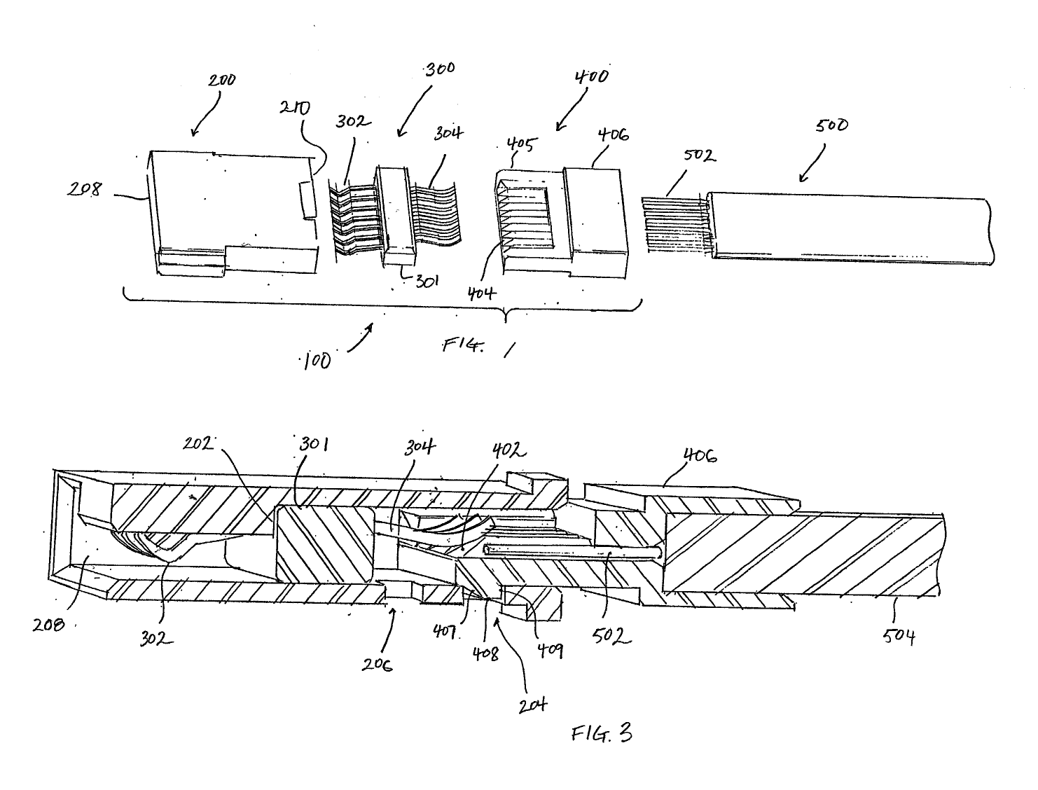

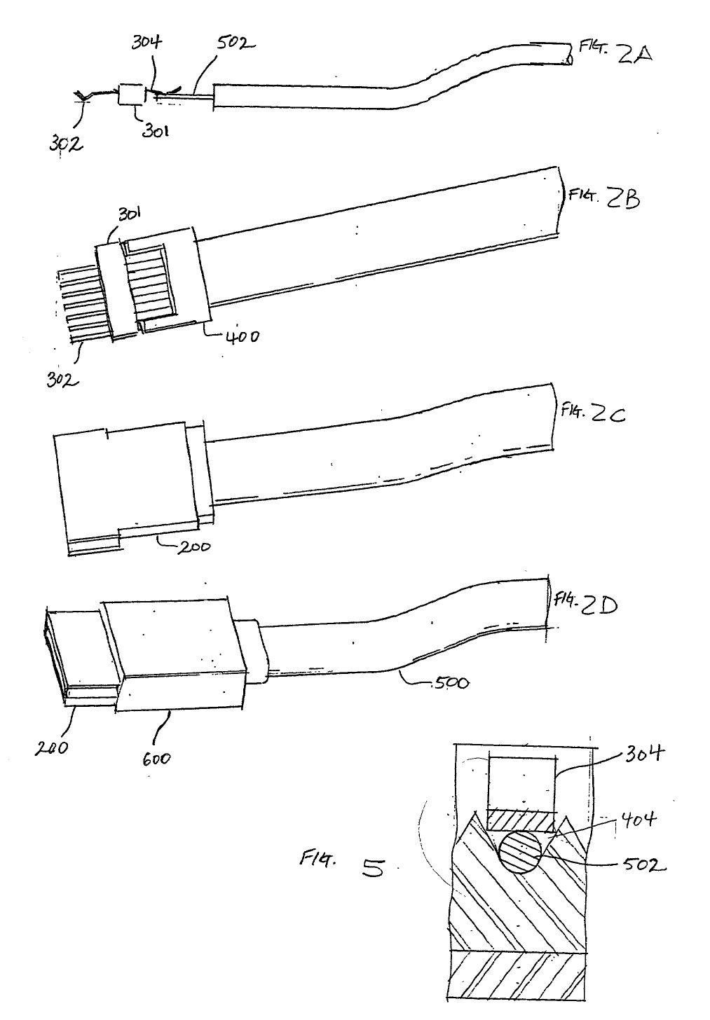

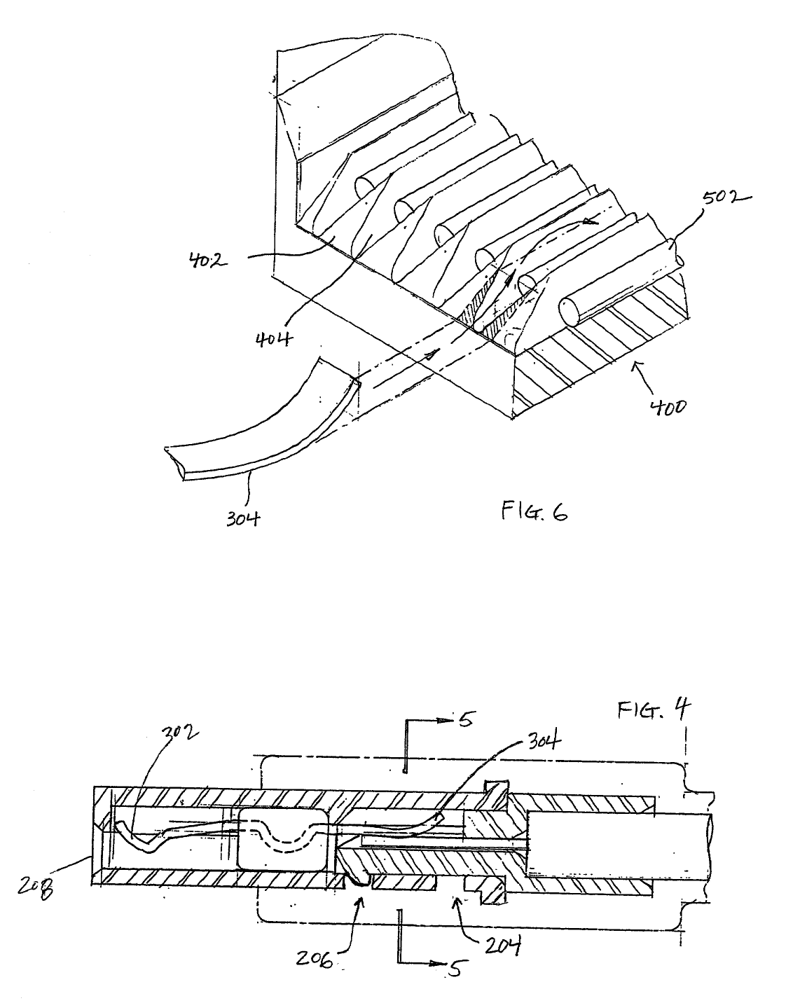

FIG. 3 shows the connector 100 in its first pre-assembly position. The housing 200 has a front opening 208 and a rear opening 210. The front opening 208 allows other electrical or electronic components to be mated to the connector 100. The rear opening 210 allows the insert 300, holding block 400 and electrical cable 500 to be inserted into the housing 200.

Adjacent the front opening 208 is a front flange 202 that extends down from a top wall of the housing 200. The insert 300 is placed into the housing 200 with a center block 301 of the insert 300 abutting the front flange 202. The center block 301 holds electrically connected front and rear metal contacts 302 and 304, respectively. The front metal contacts 302 extend forward, adjacent the front opening 208 to engage metal contacts of the other electronic components. The rear metal contacts 304 extend rearwardly into the housing 200 to engage lead wires of an electrical cable 500, as explained in further detail below. The metal contacts 302 and 304 can be a one piece stamped metal or two pieces that are connected together in the center block 301.

The holding block 400 is inserted into the rear opening 210 behind the insert 300, and secures the insert 300 inside the housing 200. A latch 408 on the front end of the holding block 400 engages a first aperture 204 of the housing 200 to secure the holding block 400 in the first position. The rear surface of the latch 409 is perpendicular to the opening 204 and prevents the holding block 400 from being withdrawn from the housing 200.

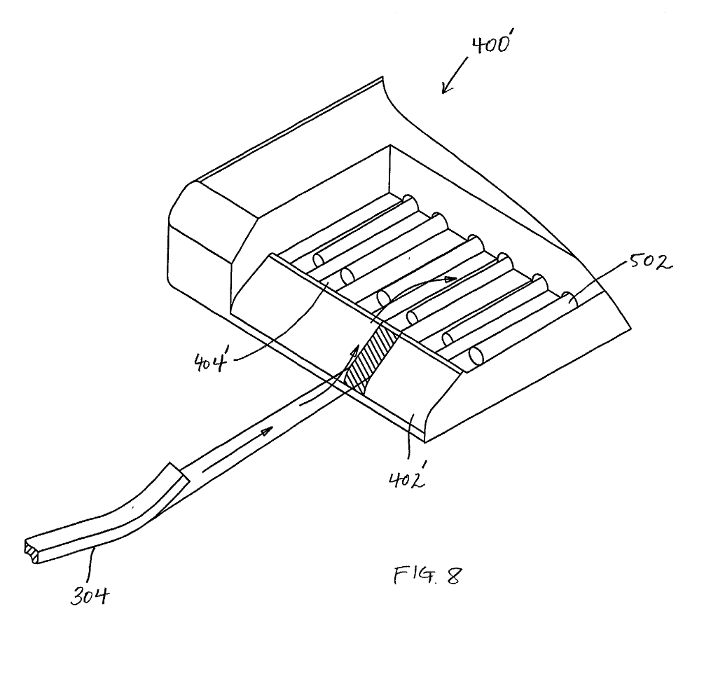

The holding block 400 has a front portion 405 having channels or grooves 404 with chamfered front faces 402, as shown in greater detail in FIG. 6. The wire leads 502 of an electrical cable 500 are inserted through the rear of the holding block 400 into the channels 404. The electrical cable 500 is secured to the holding block 400 by its rear portion 406 which frictionally engages the outer pvc-jacket 504 of the electrical cable 500.

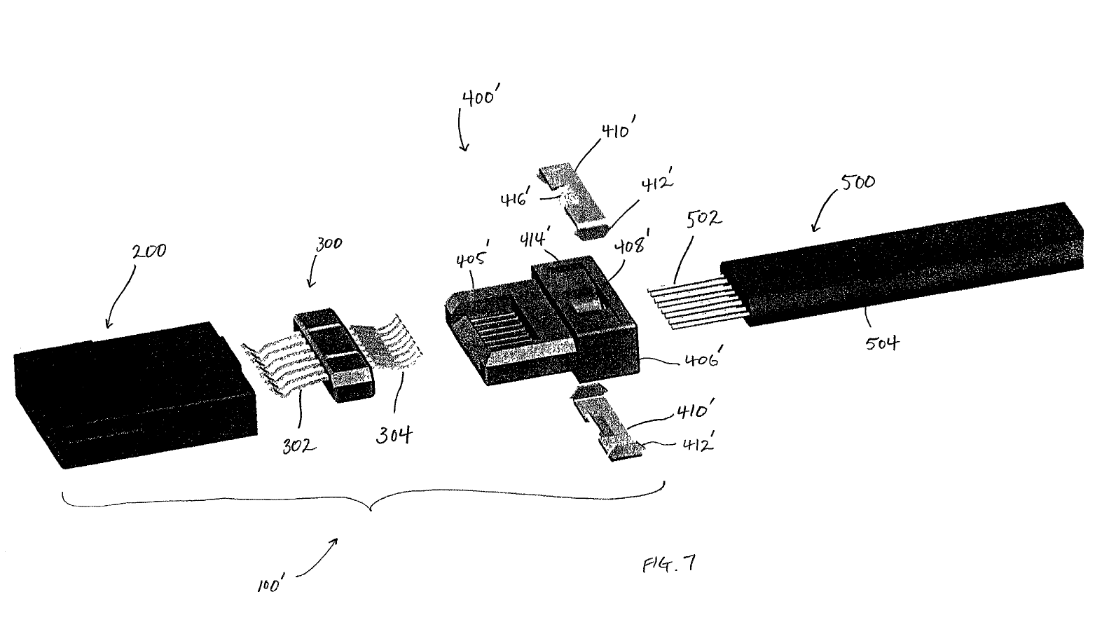

After the connector 100 and the electrical cable 500 are assembled in the first position, the holding block 400 is moved to a second locked position, shown in FIG. 4. The latch 408 has an angled front surface 407 that allows it to slidably disengage from the first aperture 204 and move to the second aperture 206. Once in the second aperture, the rear surface of the latch 409 prevents the holding block from returning to the first aperture 204.

As the holding block 400 is moved to the second position, the rear contacts 304 of the insert 300 are deflected upward by the chamfered faces 402, allowing the wire leads 502 to move underneath the rear contacts 304. When the holding block 400 is fully inserted, the rear contacts 304 drop into the channels 404 and engage the wire leads 502 by virtue of their spring-like force, as shown in FIG. 5. The spring force ensures that the rear contacts 304 remain firmly engaged with the wire leads 502.

The connector 100 of the present invention is designed to be shipped in the first position, shown in FIG. 3. The electrical cable 500 is assembled with the connector by stripping the ends of the electrical cable 500 to expose the metal wire leads 502. The electrical cable 500 is then inserted into the holding block 400, and is manually moved to the second position, where the wire leads 502 engage the insert 300.

A molding 600 can be placed over the housing 200 and wire holding block 400 by conventional over molding techniques to further secure the two components. The connector 100 and electrical cable 500 are now in their final assembled position.

The two position connector provides the advantage of allowing the connector 100 to be shipped as a single component with the holding block 400 and insert 300 being secured to the housing 200 in the first position. This makes handling the connector simpler, and eliminates the need to assembly the connector 100 prior to attaching it to the electrical cable 500. Additionally, the manual step of moving the connector 100 from the first position to the second position, and thereby electrically engaging the lead wires 502 of the electrical cable 500 to the rear contacts 304 of the insert 300, eliminates the process of having to solder the lead wires 502 to the rear contacts 304.

FIGS. 7-10 show a second preferred embodiment of the invention with the connector 100′ having a modified holding block 400′. The holding block 400′ has been altered to ensure greater contact between the wire leads 502 of the cable 500 and the rear metal contacts 304 of the insert 300, and also to better grip the cable 500 when inserted into the rear of the holding block 400′. The other elements are identical to those found in the first embodiment and have been labeled with the same reference numeral. Except for the modified holding block 400′, the assembly and operation of the second embodiment of the connector 100′ is similar to the first embodiment.

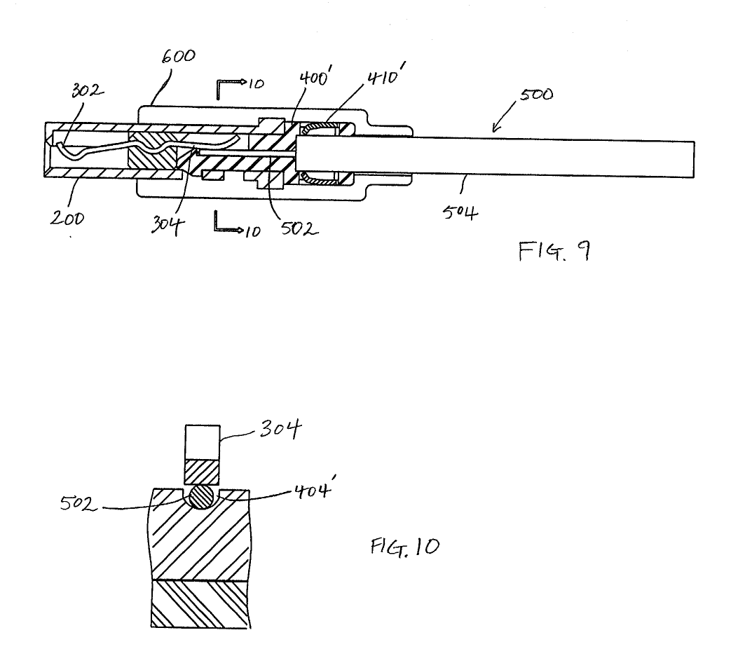

Contact between the wire leads 502 and the rear metal contacts 304 is enhanced by making the channels 404′ in the front portion 405′ of the holding block 400′ shallow and U-shaped, as best seen in FIG. 10. The depth of the channel 404′ is less than the diameter of the wire leads 502, so that some portion of the wire leads 502 are exposed above the channels 404′. This ensures that when the rear contacts 304 slides past the front face 402′ of the holding block 400′, they drop onto the wire leads 502. Additionally, the width of the U-shaped channels 404′ are slightly larger than the width of the rear contacts 304, so that if necessary, the rear contacts 304 may drop into the interior of the channels 404′ to contact the wire leads 502.

The contact between the rear contacts 304 and the wire leads 502 is further ensured by the angled face 402′ on the front portion 405′ of the holding block 400′. The rear of the angled face 402′ is perpendicular to the channels 404′, so that rear contacts 304 drop into the channels 404′ when the holding block 400′ is moved to the second position (fully inserted into the housing). This design decreases the likelihood that the angled face 405′ or the sides of the channels 404′ will prevent the rear contacts 304 from engaging the wire leads 502.

Another feature of the holding block 400′, shown in FIG. 7, are the openings or clip holes 408′ on the top and bottom surfaces of the rear portion 406′. The cable 500 is inserted into the rear portion 406′ of the holding block 400′ and metal retainer clips 410′ are placed into the openings 408′. The metal clips 410′ are then pressed inward so that transversely extending side tabs 412′ are press fit into corresponding slots 414′ in the sides of the openings 408′. Once the retainer clips 410′ are in position in the openings 408′, a center locking tab 416′ is crimped using pliers or other similar tool, to engage the outer jacket 504 of the cable 500 and prevent it from slipping rearwardly out of the holding block 400′.

FIG. 9 shows the connector 100′ having a molding 600 to secure the cable 500 in the holding block 400′. It should be understood that the molding 600 is not required in any of the embodiments of the invention and is used as an additional means to secure the cable 500 to the holding block 400′. In particular, the second embodiment of the invention, where the holding block 400′ frictionally engages the cable 500 and the metal clips 410′ secure the cable to the holding block 400′, does not require the molding 600 to secure the cable 500 to the holding block 400′.

Although preferred embodiments are specifically illustrated and described herein, it should be appreciated that many modifications and variations of the present invention are possible in light of the above teachings, without departing from the spirit or scope of the invention.

We claim:

1. A connector for attaching an electrical cable to other electronic components, comprising:
a contact insert having at least one front and rear electrical contact;
a holding block having a front portion and a rear portion, the rear portion adapted to receive an electrical cable with one or more wire leads; and
a housing for holding the insert and the holding block in a first position.

2. The connector of claim 1, wherein:
the housing has a first aperture; and
the holding block has a latch member that engages the first aperture to secure the holding block to the housing in said first position.

3. The connector of claim 2, wherein:
the housing has a second aperture defining a second position; and
wherein the holding block is movable from the first position to the second position such that the holding block latch member engages the second aperture to electrically engage the at least one rear contact of the insert to one or more wire leads of the electrical cable.

4. The connector of claim 2, wherein:
the insert is secured in the housing on a first side by a flange extending from an inner surface of the housing, and on a second side by the holding block.

5. The connector of claim 1, wherein:
the holding block has one or more channels for receiving the one or more wire leads of the electrical cable, the channels having a chamfered front surface that engage the at least one rear electrical contact of the insert.

6. The connector of claim 5, wherein:
the holding block is movable from said first position to a second position, the at least one rear electrical contact being deflected by the chamfered front surface of the one or more channels to allow the one or more wire leads of the electrical cable to slide into engagement with the at least one rear electrical contact.

7. The connector of claim 5, wherein:
the one or more channels are U-shaped and have a width greater than the width of the at least one rear electrical contact, so that said rear electrical contact can enter the channel.

8. The connector of claim 5, wherein:
the one or more channels have a depth less than the diameter of the one or more wire leads, so that a portion of each wire lead is exposed outside said channel.

9. The connector of claim 5, wherein:
the holding block has at least one clip hole; and
at least one retainer clip located within the at least one clip hole, said retainer clip being crimped to securely engage the electrical cable and prevent it from being removed from the holding block.

10. The connector of claim 1, wherein:
the at least one front and rear electrical contact is the front and rear portion of an integrated contact element.

11. A method of assembling a connector with an electrical cable comprising the steps of:
providing a connector having a housing, a contact insert and a holding block movable between a first and second position in the housing;
stripping an electrical cable to expose at least one wire lead;
inserting the electrical cable into the holding block while the connector is in the first position; and
moving the holding block to the second position to electrically engage the electrical cable with the contact insert.

12. The method of claim 11, wherein:
the housing has at least one clip hole for holding at least one retainer clip therein; and
further including the step of crimping the retainer clip to engage the electrical cable and prevent it from being removed from the holding block.

13. The method of claim 11, wherein:
the housing has a first aperture and a second aperture, and the holding block having a latch member that engages said first and second apertures to define said first and second positions, respectively.

14. The method of claim 11, wherein:
the contact insert has one or more front and rear electrical contacts;
the holding block has one or more channels for holding the at least one wire lead of the electrical cable; and
wherein said rear electrical contacts are adjacent the channels of the holding block in the first position.

15. The method of claim 14, wherein:
moving the holding block from said first position to said second position deflects the one or more rear electrical contacts so that the wire lead of the electrical cable can slide underneath and electrically engage the rear electrical contacts.

16. The method of claim 14, wherein:
the one or more channels of the holding block have chamfered front faces that deflect the one or more rear electrical contacts of the insert so that the at least one wire lead of the electrical cable can slide underneath and electrically engage the one or more rear electrical contacts as the holding block is moved for said first position to said second position.

17. A method for assembling a connector for attachment to an electrical cable comprising the steps of:
providing a housing, a contact insert, and a holding block having a first position and a second position;
inserting the insert into a rear opening in the housing; and
inserting the holding block into the rear opening in the housing to secure a rear side of the insert in the first position.

18. The method of claim 17, wherein:
the housing has a flange extending from an inner surface of the housing, the insert abutting the flange to secure a front side of the insert within the housing.

19. The method of claim 18, wherein:
the holding block engages the insert to secure a rear side of the insert within the housing, and the holding block has a latch member that engages a first aperture in the housing to secure the holding block to the housing in said first position.
